(19) United States
(12) Patent Application Publication
(10) Pub. No.: US 2026/0034947 A1
(43) Pub. Date: Feb. 5, 2026

(54) Noise, Vibration, and Harshness (NVH) Performance in Vehicles

(71) Applicant: Nissan North America, Inc., Franklin, TN (US)

(72) Inventors: Brian Haupt, Farmington Hills, MI (US); Praveen Mangalagiri, Southfield, MI (US)

(21) Appl. No.: 18/790,943

(22) Filed: Jul. 31, 2024

(51) Int. Cl. B60R 13/08; B60R 13/07; B62D 21/03; B62D 25/20; B62D 27/02

(52) U.S. Cl. CPC B60R 13/083; B60R 13/07; B62D 21/03; B62D 25/2009; B62D 27/023

(57) ABSTRACT

A vehicle that includes a chassis, which defines a passenger seating area, and a damper that is connected to the chassis beneath a floor panel of the vehicle such that the damper is positioned rearwardly of the passenger seating area.

### TECHNICAL FIELD

The present application relates to NVH performance in vehicles and, more specifically, to reductions in interior noise, vibration, etc.

### BACKGROUND

During use, vehicles are subject to a variety of inputs (e.g., from contact between the tires and the road, airflow under and around the vehicle, etc.). These inputs can create NVH issues (e.g., interior noise within the passenger seating area, vibration in the steering wheel, etc.) that result from the compounding of the natural resonant frequencies of several vibration modes.

In order to address this issue, the present disclosure describes the incorporation of a damper into a vehicle in order to alter the natural frequency of (one or more) at least one of the vibration modes, thereby reducing the overall system response and mitigating (if not entirely eliminating) the NVH issues that might otherwise occur.

### SUMMARY

In one aspect of the present disclosure, a vehicle is disclosed that includes a chassis, which defines a passenger seating area, and a damper.

The chassis includes a floor panel and a cross-member that is connected to an underside of the floor panel and which is positioned rearwardly of the passenger seating area. The cross-member extends laterally across a width of the vehicle and includes side walls and a base wall that connects the side walls such that the cross-member includes a generally U-shaped transverse cross-sectional configuration that defines a well.

The damper is positioned within the well and includes: a base panel that is connected to the base wall via first welds; a mass that is connected to the base panel via second welds and which defines recesses that are aligned with the first welds to reduce spacing between the first welds and the mass; apertures that are configured to receive locating members to facilitate manufacture and installation of the damper; a drain hole that is configured to facilitate drainage and evaporation from the damper; and channels that are configured to receive the second welds.

In certain embodiments, the chassis may further include a bulkhead that is connected to the cross-member and which is configured to increase the strength of the floor panel.

In certain embodiments, the damper may be generally aligned with the bulkhead.

In certain embodiments, the damper may be positioned beneath the bulkhead.

In certain embodiments, the mass may include plates of material that are connected together via the second welds.

In certain embodiments, the base panel may include a body with a stepped configuration.

In certain embodiments, the body may include: first and second segments that define outer ends of the body and which are connected to the base wall via the first welds; third and fourth segments that are positioned between the first and second segments and which are spaced vertically from the base wall by a first distance, wherein the third and fourth segments are connected to the mass via the second welds; and a fifth segment that is positioned between the third and fourth segments and which is spaced vertically from the base wall by a second distance that is less than the first distance to thereby define a gap between the fifth segment and the mass.

In another aspect of the present disclosure, a vehicle is disclosed that includes a chassis and a damper. The chassis defines a passenger seating area and includes a floor panel, and the damper is connected to the chassis beneath the floor panel rearwardly of the passenger seating area.

In certain embodiments, the damper may be generally aligned with a lateral centerline of the vehicle.

In certain embodiments, the damper may include a weight that lies substantially within the range of approximately 1.5 kg to approximately 2 kg.

In certain embodiments, the damper may include apertures that extend therethrough and which are configured to receive locating members to facilitate manufacture and installation of the damper.

In certain embodiments, the damper may include a drain hole that extends therethrough and which is configured to facilitate drainage and evaporation from the damper.

In certain embodiments, the damper may include a base panel and a mass that is connected to the base panel.

In certain embodiments, the base panel and the mass may be configured as discrete components of the damper.

In certain embodiments, the damper may include channels that extend therethrough and which are configured to receive welds connecting the base panel and the mass.

In certain embodiments, the base panel may include: first and second segments that are connected to the chassis; third and fourth segments that are positioned between the first and second segments and which are connected to the mass; and a fifth segment that is positioned between the third and fourth segments and which is devoid of engagement with either the chassis or the mass.

In certain embodiments, the mass may be laminated in construction.

In another aspect of the present disclosure, a method of assembling a vehicle is disclosed that includes providing a damper, and connecting the damper to a chassis of the vehicle such that the damper is positioned rearwardly of a passenger seating area, wherein the damper includes a base panel and a mass that is connected to the base panel, and the chassis includes a floor panel and a cross-member that is connected to the floor panel and which extends laterally across a width of the vehicle.

In certain embodiments, connecting the damper to the chassis may include positioning the damper within the cross-member such that the damper is positioned beneath the floor panel.

In certain embodiments, connecting the damper to the chassis may include positioning the damper such that the damper is generally aligned with a lateral centerline of the vehicle.

In certain embodiments, connecting the damper to the chassis may include connecting the base panel to the chassis via welds.

In certain embodiments, connecting the base panel to the chassis may include aligning the welds with recesses defined by the mass to reduce spacing between the welds and the mass.

### BRIEF DESCRIPTION OF THE DRAWINGS

According to common practice, the various features of the drawings may not be to-scale, and the dimensions of the various features may be arbitrarily expanded or reduced. Additionally, in the interest of clarity, certain components, elements, and/or features may be omitted from certain drawings in the interest of clarity.

FIG. 1 is a partial, cross-sectional view of a vehicle that includes a chassis and a damper that is connected to the chassis in accordance with the principles of the present disclosure.

FIG. 2 is a partial, bottom, plan view of the chassis.

FIG. 3 is a cross-sectional view taken along line 3-3 in FIG. 2.

FIG. 4 is a partial, top, plan view of the chassis and the damper.

FIG. 5 is a partial, perspective view of the chassis and the damper (with the chassis shown in phantom).

FIG. 6 is a cross-sectional view taken along line 6-6 in FIG. 4.

FIG. 7 is a top, perspective view of the damper, which includes a base panel and a mass.

FIG. 8 is a top, perspective view of the base panel.

### DETAILED DESCRIPTION

The present disclosure describes a vehicle that includes a chassis and a damper that is connected to the chassis beneath a floor panel of the vehicle. The damper is positioned (located) rearwardly of the passenger seating area and is connected (secured) (e.g., welded) to a cross-member that extends laterally across the width of the vehicle. The cross-member is connected (secured) (e.g., welded) to an underside of the floor panel, thereby concealing the damper within the chassis.

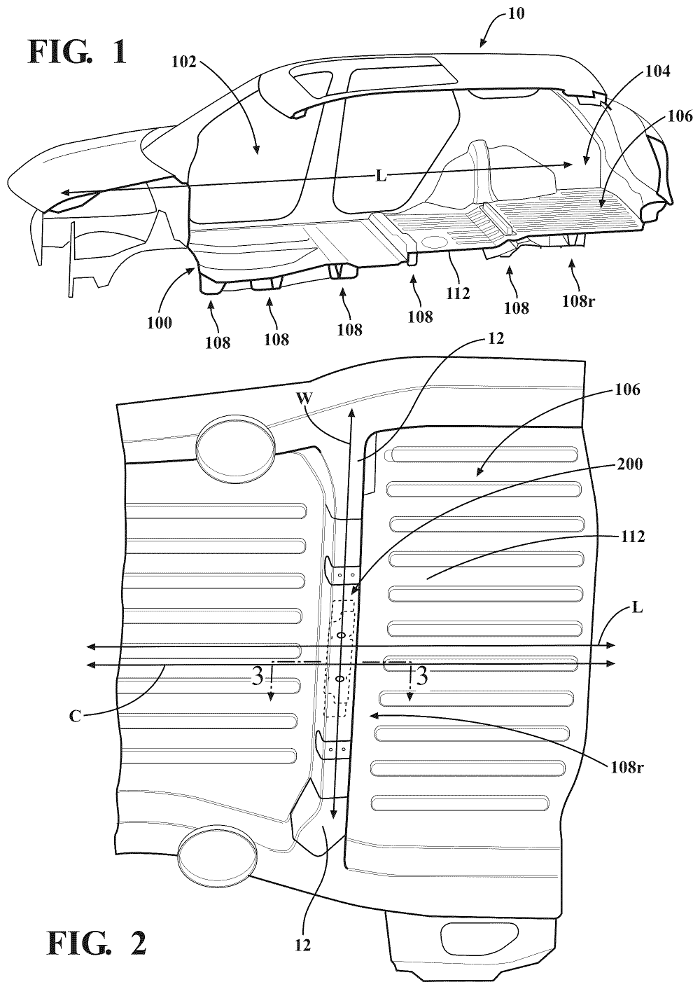

With reference to FIGS. 1-6, a vehicle 10 is disclosed that includes a chassis 100 and a damper 200. Although generally illustrated and described in the context of a passenger vehicle, it should be appreciated that the principles of the present disclosure may be applied to a wide variety of vehicles (e.g., trucks, SUVs, vans, buses, boats, airplanes, trains, etc.).

The chassis 100 defines a passenger seating area 102 (FIG. 1), which accommodates a plurality of seats (not shown) (e.g., first (front) row seats and second (rear) row seats), and a cargo area 104, which is positioned (located) rearwardly of the passenger seating area 102 along a length L of the vehicle 10. As seen in FIGS. 1 and 2, the chassis 100 includes a floor panel 106 and a plurality of cross-members (braces) 108, which extend laterally across a width W of the vehicle 10 (i.e., in generally orthogonal relation to the length L) and increase the strength (e.g., the rigidity) of the floor panel 106.

Although the floor panel 106 and the cross-members 108 are shown as discrete components of the chassis 100, embodiments in which the floor panel 106 and the cross-members 108 may be unitarily (integrally, monolithically) formed from a single piece of material are also envisioned herein and would not be beyond the scope of the present disclosure.

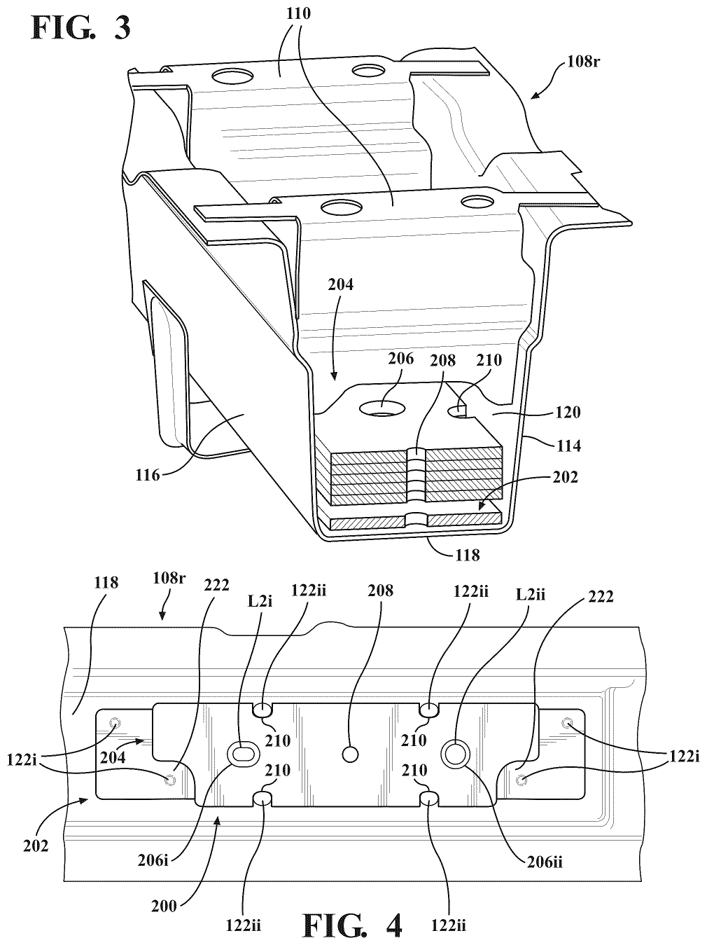

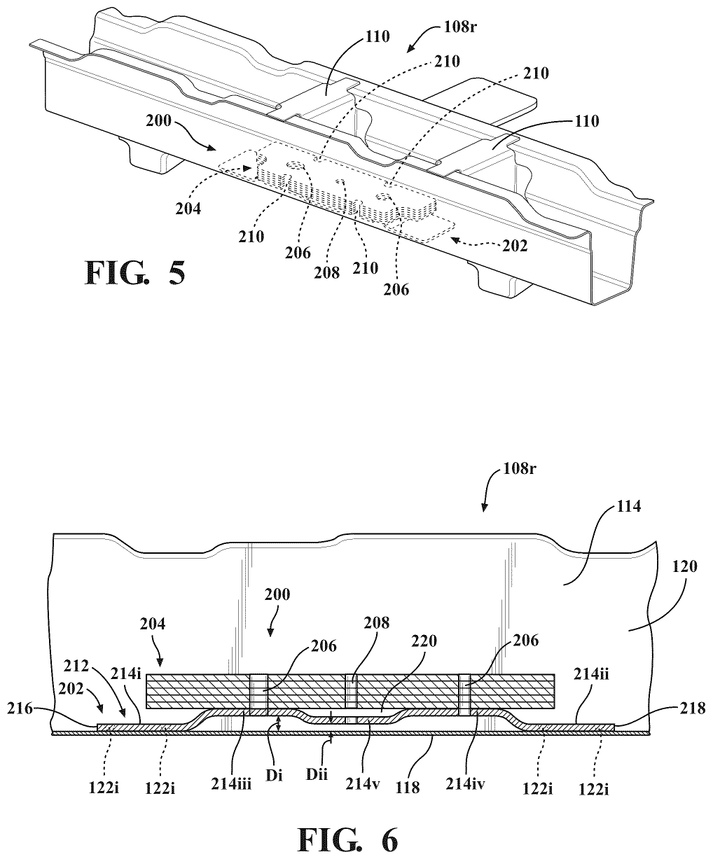

In certain embodiments, it is envisioned that the chassis 100 may further include (one or more) at least one bulkhead (bracket) 110 (FIGS. 3, 5) that is connected (secured) (e.g., welded) to (one or more) at least one of the cross-members 108. The bulkhead(s) 110 extend across (span) the cross-member(s) 108 and are configured to further increase the strength (e.g., the rigidity) of the floor panel 106.

The cross-members 108 are connected (secured) to an underside (bottom surface) 112 (FIGS. 1, 2) of the floor panel 106 and each include side walls 114, 116 (FIG. 3) and a base wall 118. The base wall 118 connects the side walls 114, 116 such that the cross-members 108 each include a generally U-shaped transverse cross-sectional configuration that defines a well (cavity) 120.

The damper 200 is connected to the chassis 100 and is configured to shift the natural (resonant) frequency of the floor panel 106, which reduces noise and vibration (e.g., in the frequency range of approximately 160 Hz to approximately 200 Hz) caused by contact between the tires and the road, airflow under and around the vehicle 10, etc., thereby improving NVH performance of the vehicle 10. More specifically, in the illustrated embodiment, the damper 200 is connected (secured) to (or otherwise supported by) a rearmost cross-member 108r and is positioned (located, retained) within the well 120 thereof. Positioning of the damper 200 within the rearmost cross-member 208r not only conceals the damper 200 beneath the floor panel 106, thereby obscuring the damper 200 from view, but simplifies assembly of the vehicle 10 by avoiding interference from other components during installation. Embodiments in which the damper 200 may be connected (secured) to (or otherwise supported by) the underside 112 of the floor panel 106 are also envisioned herein, however, and would not be beyond the scope of the present disclosure.

Although shown and described as including a single damper 200, embodiments in which the vehicle 10 may include a plurality of dampers 200 are also envisioned herein (e.g., depending upon the particular configuration of the vehicle 10, the natural frequency of the floor panel 106, etc.) and would not be beyond the scope of the present disclosure. In such embodiments, it is envisioned that the dampers 200 may be connected (secured) to (or otherwise supported by) a common cross-member 108 (e.g., the rearmost cross-member 108r) or different cross-members 108, to several of the cross-members 108, to the floor panel 106, or to any other structure(s) suitable for the intended purpose of improving NVH performance of the vehicle 10 in the manner described herein.

As seen in FIGS. 1 and 2, the rearmost cross-member 108r and, thus, the damper 200 are positioned (located) rearwardly of the passenger seating area 102 (i.e., beneath the cargo area 104). More specifically, the rearmost cross-member 108r is connected (secured) (e.g., welded) to rear shock towers 12 (FIG. 2) of the vehicle 10 and is generally aligned with a rear axle thereof (not shown) (i.e., along the length L), which facilitates and improves the channeling of input (e.g., vibration) from rear wheels (not shown) of the vehicle 10 to the damper 200. Embodiments in which the rearmost cross-member 108r and the damper 200 may be positioned beneath the passenger seating area 102 are also envisioned herein, however. For example, an embodiment of the vehicle 10 including a third row of seats that is positioned (located) above the rearmost cross-member 108r and the damper 200 would not be beyond the scope of the present disclosure.

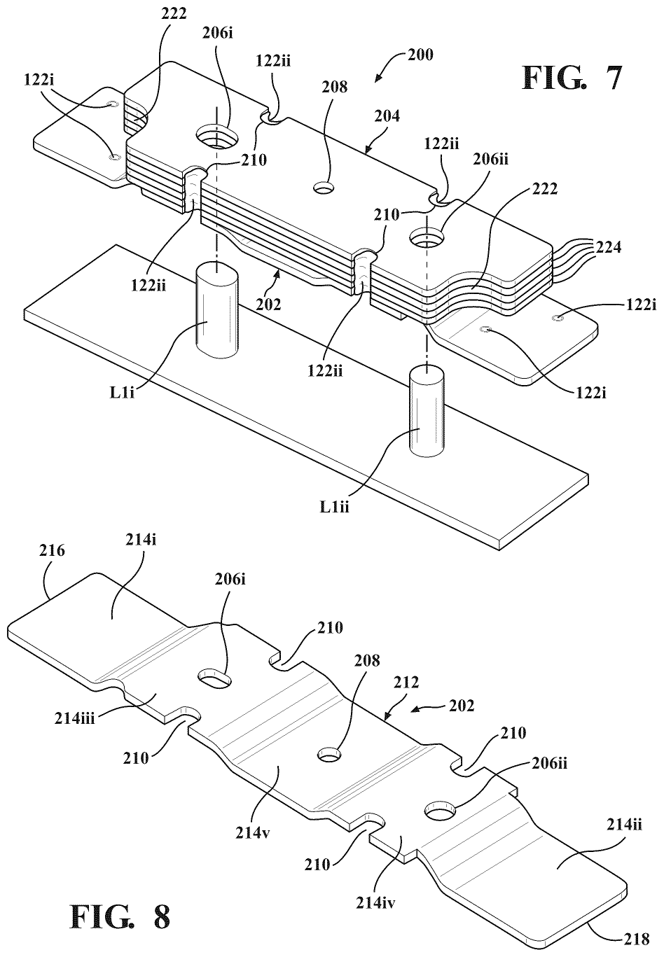

Referring now to FIGS. 7 and 8 as well, the damper 200 includes: a base panel 202; a mass 204; apertures 206; (one or more) at least one drain hole 208; and channels 210. In the illustrated embodiment, the damper 200 includes a weight that lies substantially within the range of approximately 1.5 kg to approximately 2 kg. Embodiments in which the weight of the damper 200 may lie outside of the disclosed range are also envisioned herein, however, and would not be beyond the scope of the present disclosure. For example, in embodiments of the vehicle 10 that include a third row of seats, it is envisioned that the weight of the damper 200 may be reduced and offset by the weight thereof.

The base panel 202 is connected (secured) to the base wall 118 of the rearmost cross-member 108r (i.e., within the well 120 thereof) via (first) welds 122i such that the damper 200 is generally aligned with a lateral centerline C (FIG. 2) of the vehicle 10 (i.e., along the width W thereof). More specifically, in the illustrated embodiment, the damper 200 is positioned (located) beneath and is generally aligned with the at least one bulkhead 110, as seen in FIGS. 3 and 5. Embodiments in which the specific position (location) of the damper 200 may be varied are also envisioned herein (e.g., depending upon the particular configuration of the vehicle 10, the natural frequency of the floor panel 106, etc.), however, and would not be beyond the scope of the present disclosure.

The base panel 202 includes a body 212 (FIGS. 6, 8) with a stepped (i.e., non-linear, terraced) configuration. More specifically, the body 212 includes: (first and second) segments 214i, 214ii, which respectively define outer ends 216, 218 of the body 212 and are connected (secured) to the chassis 100 (i.e., the base wall 118 of the rearmost cross-member 108r) via the welds 122i; (third and fourth) segments 214iii, 214iv, which are positioned between the segments 214i, 214ii and are connected (secured) to the mass 204 via (second) welds 122ii (FIGS. 4, 7); and a fifth segment 214v, which is positioned between the segments 214iii, 214iv. As seen in FIG. 6, the base panel 202 is configured such that the segments 214iii, 214iv are spaced (vertically) from the base wall 118 by a (first) distance Di and such that the segment 214v is spaced (vertically) from the base wall 118 by a (second) distance Dii. The distance Dii is less than the distance Di, whereby a gap 220 is defined between the segment 214v and the mass 204 that renders the segment 214v devoid of any engagement (contact) with either the chassis 100 (i.e., the rearmost cross-member 108r) or the mass 204. Eliminating engagement (contact) between the segment 214v and the mass 204 not only inhibits (if not entirely prevents) rattle of the damper 200 but facilitates drainage and evaporation by allowing for the escape of water and allows for increased distribution of coating(s) (e.g., during painting, waterproofing, etc.).

The mass 204 is connected (secured) to the base panel 202 via the welds 122ii and defines recesses (cutouts, notches) 222. As seen in FIGS. 4 and 7, the recesses 222 are aligned with (and receive) the welds 122i, which reduces spacing between the welds 122i and the mass 204 (e.g., in order to increase stability upon connection of the damper 200 to the chassis 100).

In the illustrated embodiment, the base panel 202 and the mass 204 are configured as discrete components of the damper 200. Embodiments in which the damper 200 may include a unitary (monolithic, integral) construction (i.e., such that the base panel 202 and the mass 204 are formed from a single piece of material) are also envisioned herein, however, and would not be beyond the scope of the present disclosure. For example, it is envisioned that forming the base panel 202 and the mass 204 from a single piece of material may simplify manufacturing of the damper 200 by obviating the welds 122ii.

In the illustrated embodiment, the mass 204 is laminated in construction and includes a plurality of (generally identical) plates (layers) 224 (FIG. 7) of (metallic) material, which are connected (secured) together via the welds 122ii. Embodiments in which the mass 204 may include a unitary (monolithic, integral) construction (i.e., such that the mass 204 is formed from a single piece of material) are also envisioned herein, however, and would not be beyond the scope of the present disclosure.

The apertures 206 extend through the damper 200 (i.e., the base panel 202 and the mass 204) and facilitate both manufacturing and installation of the damper 200, as described in further detail below. In the illustrated embodiment, the damper 200 includes (first and second) apertures 206i, 206ii, which are non-identical in configuration. More specifically, as seen in FIGS. 4 and 7, the aperture 206i includes a non-annular (e.g., elliptical) transverse cross-sectional configuration, and the aperture 206ii includes a generally annular (i.e., circular) transverse cross-sectional configuration. Embodiments in which the damper 200 may include generally identical apertures 206 are also envisioned herein (e.g., depending upon the particular installation site in the vehicle 10, the configuration of the chassis 100, etc.), however, and would not be beyond the scope of the present disclosure.

During manufacturing of the damper 200, the apertures 206i, 206ii respectively receive (first) locating members (pins) L1i, L1ii (FIG. 7), which correspond in configuration thereto and are utilized to align the plates 224 and the base panel 202. During installation of the damper 200, the apertures 206i, 206ii respectively receive (second) locating members (pins) L2i, L2ii (FIG. 4) on the chassis 100 (i.e., the rearmost cross-member 108r), which correspond in configuration thereto and are utilized to align the damper 200 in relation to the chassis 100. More specifically, due to the respective corresponding non-identical configurations of the apertures 206i, 206ii and the locating members L2i, L2ii, the damper 200 is connectable to the chassis 100 in a single orientation.

The drain hole(s) 208 extend through the damper 200 (i.e., the base panel 202 and the mass 204) and not only facilitate drainage and evaporation by further allowing for the escape of water (i.e., from between the plates 224) but increase distribution of the aforementioned coating(s) (i.e., between the plates 224).

The channels 210 extend through the damper 200 (i.e., the base panel 202 and the mass 204) and facilitate assembly and installation of the damper 200. More specifically, the channels 210 receive the welds 122ii, which connect (secure) together the plates 224 to form the mass 204 and connect (secure) together the mass 204 and the base panel 202.

With reference now to FIGS. 1, 2, 4, and 7 in particular, a method of assembling the vehicle 10 will be discussed.

Initially, the damper 200 (FIG. 7) is manufactured and provided by stamping the base panel 202 and the plates 224, during which, the apertures 206, the drain hole(s) 208, the channels 210, and the recesses 222 are formed. The base panel 202 and the plates 224 are then aligned (i.e., via respective insertion of the locating members L1i, L1ii into the apertures 206i, 206ii) and are subjected to an initial (first) welding procedure. During the initial welding procedure, the welds 122ii are formed within the channels 210 in order to connect (secure) the plates 224 together, thereby forming the mass 204, and connect (secure) the mass 204 to the base panel 202, thereby forming the damper 200.

The assembled damper 200 is then inserted into (positioned within) the rearmost cross-member 108r (FIG. 4) (i.e., the well 120) and is aligned therewith (i.e., via respective insertion of the locating members L2i, L2ii into the apertures 206i, 206ii). The damper 200 is then secured (connected) to the chassis 100 during a final (second) welding procedure such that the damper 200 is positioned (located) rearwardly of the passenger seating area 102 (FIG. 1) in general alignment with the lateral centerline C (FIG. 2) of the vehicle 10. During the final welding procedure, the base panel 202 is connected (secured) to the chassis 100 (i.e., the base wall 118 of the rearmost cross-member 108r) via the welds 122i (FIG. 4), which are aligned with and received by the recesses 222.

Following installation of the damper 200, the rearmost cross-member 108r is secured (connected) to the floor panel 106 (FIGS. 1, 2) (e.g., via welding, via mechanical fasteners, etc.) such that the damper 200 is positioned (located) beneath the floor panel 106 and is concealed within the chassis 100.

Persons skilled in the art will understand that the various embodiments of the disclosure described herein and shown in the accompanying figures constitute non-limiting examples, and that additional components and features may be added to any of the embodiments discussed herein above without departing from the scope of the present disclosure. Additionally, persons skilled in the art will understand that the elements and features shown or described in connection with one embodiment may be combined with those of another embodiment without departing from the scope of the present disclosure and will appreciate further features and advantages of the presently disclosed subject matter based on the description provided. Variations, combinations, and/or modifications to any of the embodiments and/or features of the embodiments described herein that are within the abilities of a person having ordinary skill in the art are also within the scope of the disclosure, as are alternative embodiments that may result from combining, integrating, and/or omitting features from any of the disclosed embodiments.

Use of broader terms such as “comprises,” “includes,” and “having” should be understood to provide support for narrower terms such as “consisting of,” “consisting essentially of,” and “comprised substantially of” Accordingly, the scope of protection is not limited by the description set out above, but is defined by the claims that follow, and includes all equivalents of the subject matter of the claims.

In the preceding description, reference may be made to the spatial relationship between the various structures illustrated in the accompanying drawings, and to the spatial orientation of the structures. However, as will be recognized by those skilled in the art after a complete reading of this disclosure, the structures described herein may be positioned and oriented in any manner suitable for their intended purpose. Thus, the use of terms such as “above,” “below,” “upper,” “lower,” “inner,” “outer,” “left,” “right,” “upward,” “downward,” “inward,” “outward,” etc., should be understood to describe a relative relationship between the structures and/or a spatial orientation of the structures. Those skilled in the art will also recognize that the use of such terms may be provided in the context of the illustrations provided by the corresponding figure(s).

Additionally, terms such as “approximately,” “generally,” “substantially,” and the like should be understood to allow for variations in any numerical range or concept with which they are associated and encompass variations on the order of 25% (e.g., to allow for manufacturing tolerances and/or deviations in design). For example, the term “generally parallel” should be understood as referring to configurations in with the pertinent components are oriented so as to define an angle therebetween that is equal to 180°+25% (i.e., an angle that lies within the range of (approximately) 135° to (approximately) 225°) and the term “generally orthogonal” should be understood as referring to configurations in with the pertinent components are oriented so as to define an angle therebetween that is equal to 90°±25% (i.e., an angle that lies within the range of (approximately) 67.5° to (approximately) 112.5°). The term “generally parallel” should thus be understood as referring to encompass configurations in which the pertinent components are arranged in parallel relation, and the term “generally orthogonal” should thus be understood as referring to encompass configurations in which the pertinent components are arranged in orthogonal relation.

Although terms such as “first,” “second,” “third,” etc., may be used herein to describe various operations, elements, components, regions, and/or sections, these operations, elements, components, regions, and/or sections should not be limited by the use of these terms in that these terms are used to distinguish one operation, element, component, region, or section from another. Thus, unless expressly stated otherwise, a first operation, element, component, region, or section could be termed a second operation, element, component, region, or section without departing from the scope of the present disclosure.

Each and every claim is incorporated as further disclosure into the specification and represents embodiments of the present disclosure. Also, the phrases “at least one of A, B, and C” and “A and/or B and/or C” should each be interpreted to include only A, only B, only C, or any combination of A, B, and C.

What is claimed is:

1. A vehicle comprising:
a chassis defining a passenger seating area, wherein the chassis includes:
a floor panel; and
a cross-member connected to an underside of the floor panel and positioned rearwardly of the passenger seating area, wherein the cross-member extends laterally across a width of the vehicle and includes:
side walls; and
a base wall connecting the side walls such that the cross-member includes a generally U-shaped transverse cross-sectional configuration defining a well; and
a damper positioned within the well, wherein the damper includes:
a base panel connected to the base wall via first welds;
a mass connected to the base panel via second welds, wherein the mass defines recesses aligned with the first welds to reduce spacing between the first welds and the mass;
apertures configured to receive locating members to facilitate manufacture and installation of the damper;
a drain hole configured to facilitate drainage and evaporation from the damper; and
channels configured to receive the second welds.

2. The vehicle of claim 1, wherein the chassis further includes a bulkhead connected to the cross-member and configured to increase strength of the floor panel, wherein the damper is generally aligned with and is positioned beneath the bulkhead.

3. The vehicle of claim 1, wherein the mass includes plates of material connected together via the second welds.

4. The vehicle of claim 1, wherein the base panel includes a body with a stepped configuration.

5. The vehicle of claim 4, wherein the body includes:
first and second segments defining outer ends of the body and connected to the base wall via the first welds;
third and fourth segments positioned between the first and second segments, wherein the third and fourth segments are spaced vertically from the base wall by a first distance and are connected to the mass via the second welds; and
a fifth segment positioned between the third and fourth segments, wherein the fifth segment is spaced vertically from the base wall by a second distance less than the first distance to thereby define a gap between the fifth segment and the mass.

6. A vehicle comprising:
a chassis defining a passenger seating area, wherein the chassis includes a floor panel; and
a damper connected to the chassis beneath the floor panel rearwardly of the passenger seating area.

7. The vehicle of claim 6, wherein the damper is generally aligned with a lateral centerline of the vehicle.

8. The vehicle of claim 6, wherein the damper includes a weight substantially within a range of approximately 1.5 kg to approximately 2 kg.

9. The vehicle of claim 6, wherein the damper includes apertures extending therethrough configured to receive locating members to facilitate manufacture and installation of the damper.

10. The vehicle of claim 6, wherein the damper includes a drain hole extending therethrough configured to facilitate drainage and evaporation from the damper.

11. The vehicle of claim 6, wherein the damper includes:
a base panel; and
a mass connected to the base panel.

12. The vehicle of claim 11, wherein the base panel and the mass are configured as discrete components of the damper.

13. The vehicle of claim 12, wherein the damper includes channels extending therethrough configured to receive welds connecting the base panel and the mass.

14. The vehicle of claim 11, wherein the base panel includes:
first and second segments connected to the chassis;
third and fourth segments positioned between the first and second segments and connected to the mass; and
a fifth segment positioned between the third and fourth segments, wherein the fifth segment is devoid of engagement with either the chassis or the mass.

15. The vehicle of claim 11, wherein the mass is laminated in construction.

16. A method of assembling a vehicle, the method comprising:
providing a damper including:
a base panel; and
a mass connected to the base panel; and
connecting the damper to a chassis of the vehicle such that the damper is positioned rearwardly of a passenger seating area, wherein the chassis includes:
a floor panel; and
a cross-member connected to the floor panel and extending laterally across a width of the vehicle.

17. The method of claim 16, wherein connecting the damper to the chassis includes positioning the damper within the cross-member such that the damper is positioned beneath the floor panel.

18. The method of claim 16, wherein connecting the damper to the chassis includes positioning the damper such that the damper is generally aligned with a lateral centerline of the vehicle.

19. The method of claim 16, wherein connecting the damper to the chassis includes connecting the base panel to the chassis via welds.

20. The method of claim 19, wherein connecting the base panel to the chassis includes aligning the welds with recesses defined by the mass to reduce spacing between the welds and the mass.
